(19) United States
(12) Patent Application Publication
(10) Pub. No.: US 2007/0143273 A1
(43) Pub. Date: Jun. 21, 2007

(54) Search engine with increased performance and specificity

(76) Inventors: William A. Knaus, Charlottesville, VA (US); Mir Said Siadaty, Charlottesville, VA (US)

Correspondence Address: NOVAK DRUCE & QUIGG, LLP, 1300 EYE STREET NW, SUITE 1000 WEST TOWER, WASHINGTON, DC, 20005, US

(21) Appl. No.: 11/635,815

(22) Filed: Dec. 8, 2006

Related U.S. Application Data
(60) Provisional application No. 60/748,156, filed on Dec. 8, 2005.
(60) Provisional application No. 60/778,096, filed on Mar. 2, 2006.
(60) Provisional application No. 60/826,889, filed on Sep. 25, 2006.

(51) Int. Cl. G06F 17/30

(52) U.S. Cl. 707/3

(57) ABSTRACT

The present invention discloses a system and methods for retrieval of most relevant information from a given digital data repository. This is done in the first step by verifying two conditions of relevance, presence of query words plus presence of at least one type of relationship between the words in the data record. Additionally a numeric relevance score is computed for each relevant record, such that they can be sorted descendingly according to this relevance metric. The most relevant results will be shown first, while irrelevant records are eliminated. This reduces the volume of the results substantially. The information retrieval system according to this invention includes: a data pre-processing component where multiple steps of processing is performed, a second new data repository where the modified data is stored, a user interface with the capability of real-time translation of user's query, a search engine, and computing hardware in a distributed architecture.

### REFERENCE TO RELATED APPLICATIONS

This application claims priority to U.S. Provisional Application Nos. 60/748,156 filed Dec. 8, 2005, 60/778,096 filed Mar. 2, 2006, and 60/826,889 filed Sep. 25, 2006, eah entitled “Method for Increasing Search Performance and Specificity, and for Decreasing Result Volume, Simultaneously,” the entireties of which are incorporated by reference.

### BACKGROUND OF THE INVENTION

1. Field of the Invention

The present invention is directed toward a search engine. More particularly, the present invention is directed toward a natural language processing (NLP) search engine that involves new and novel methods for increasing search performance, specificity, retrieval precision and recall, and for decreasing result volume, simultaneously. The invention also relates to the searching data and statistics to represent human knowledge uncertainty, computer science to build tools, and biomedicine to provide the impetus and content on which the preferred embodiment of the invention performs. The present invention provides new and novel methods to define and measure relevance of documents found by the search engine, which can be applied to a variety of situations.

2. Description of the Background

Presently, a substantial portion of the large amounts of data produced in different organizations is recorded in digital format. This format enables search engines to access and retrieve digital data stored therein. There is a trend to increase the volume of data a search engine can access and index. This has obvious advantages, but produces new challenges. One needs to increase retrieval specificity while maintaining an acceptable sensitivity. Specificity is the percentage of irrelevant records that can be eliminated, while sensitivity is the percentage of relevant records that can be found and shown to the user.

Methods that eliminate increasingly more of the irrelevant articles will also tend to miss more of the relevant ones. Plus, as the total number of records in a database increases, it becomes increasingly hard to eliminate irrelevant articles without missing the relevant ones. Table 1 below gives a scenario for a database with 16 million records (similar in size to MEDLINE—National Library of Medicine's medline and pre-medline database). The search engine is assumed to work with 99% sensitivity (=recall, which is percentage of all relevant articles retrieved by the engine) and 99.99% specificity (percentage of all irrelevant articles eliminated by the engine); thus equivalent to an odds ratio of one million. Nevertheless, the majority of retrieved records (>76%) are irrelevant. One may be able to tune the search engine to increase the specificity even further (to 99.9999%), but it will decrease the sensitivity (to 50%), according to the theory of signal detectability. This means that half of all relevant articles will be missed. To attain higher specificity without sacrificing sensitivity, the overall performance of the search has to increase.

TABLE 1
Tuning a search engine to attain two different scenarios of retrieval.

| Scenario 1. Query with specificity of 99.99% is | | Scenario 2. The price for a very high specificity: | |
|---|---|---|---|
| insufficient for a database of 16 million records. | | Missing a large number of relevant records. | |
| odds ratio | 1,000,000.00 | odds ratio | 1,000,000.00 |
| Specificity | 99.99% | specificity | 99.9999% |
| sensitivity | 99.01% | sensitivity (recall) | 50.00% |
| (recall) | | precision | 93.99% |
| Precision | 23.63% | | |

| | |
|---|---|
| 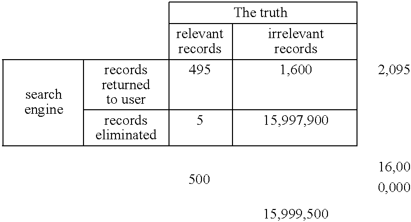 | 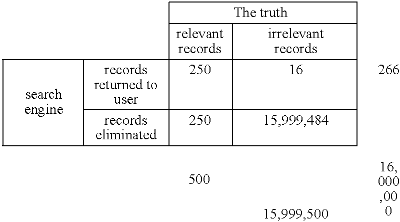 |

MEDLINE indexes more than 15 million citations in the fields of medicine, nursing, dentistry, veterinary medicine, the health care system, and the preclinical sciences. Encountering extraneous articles in response to a query submitted to MEDLINE/PubMed is not uncommon. However, every one of the articles retrieved contains all of the query words. This leads to the conclusion that the presence of query words in an article is not a sufficient condition for the article to be relevant to user's query, although it is a necessary.

About 83% of queries sent to PubMed, NLM's search engine for MEDLINE, are multi-word queries. When submitting a query with multiple words, the user is usually interested in some type of relationship between the words, such that the “presence of relationship” between the query words in the article also becomes a necessary condition for relevance.

There are methods to ascertain the presence and type of relationship between two words in a text. There are also numerous search engines, user interfaces, and software tools for retrieval of articles and information from MEDLINE. Table 2 lists some of them, but none of them detects either the presence or the type of relationship. Further research into these methods is needed before they can be implemented in the retrieval systems of MEDLINE.

TABLE 2
Examples of retrieval services for MEDLINE

| | | relevance | |
|---|---|---|---|
| Service | availability | score | description |
| PubMed | public/free | no | NLM's search engine for MEDLINE |
| SLIM | public/free | no | alternative search interface using slider controllers |
| | | | to implement search limits, methodology filters, and |
| | | | MeSH terminologies |
| askMEDLINE | public/free | no | free-text, natural language query tool for PubMed |
| eTBLAST | public/free | yes | inputs an entire paragraph and returns articles that |
| | | | are similar to it |
| Ovid's MEDLINE | subscription required | no | a search engine to MEDLINE |
| HubMed | public/free | yes | shows first the articles that contain the search terms |
| | | | most frequently in the title and/or abstract |
| PubMedAssistant | public/free | no | biologist-friendly interface for enhanced PubMed |
| | | | search |
| CISMeF | public/free | no | gives ranked list of relevant specialties that relate to |
| | | | topics discussed in each article |
| GoPubMed | public/free | no | classifies the retrieved articles using Gene Ontology |
| | | | terms |
| AnneOTate | public/free | no | A tool for summarizing the results of a PubMed |
| | | | query |
| ArrowSmith | public/free | no | A tool for identifying links between two sets of |
| | | | Medline articles |
| PubMed Gold | public/free | no | finds PDFs for PubMed citations |

In addition to trying to prevent irrelevant articles from appearing in the retrieved articles, one may also locate and isolate irrelevant articles that have been retrieved. This can be done by estimating a relevance score for each retrieved article, and then sorting the articles by the score. Irrelevant retrieved articles will be shifted to the end of the list, effectively hidden from the user. Among the implemented information retrieval systems for MEDLINE, some do define relevance scores. These relevance scores are mainly based on frequency and place of occurrence of keywords extracted from the user's query. They do not incorporate the presence of a relationship between the query words.

If two words occur within an article, the probability that a relation between them is explained is clearly higher when the words occur within the same sentence (or adjacent sentences) versus remote sentences. This is a probabilistic expression of linguistic common sense. Therefore, sentence-level concurrence (co-occurrence) can be used as a surrogate for existence of the relationship between the words.

The present invention, an embodiment of which is called ReleMed (www.ReleMed.com), retrieves relevant articles by detecting sentence-level concurrence of search terms. The present invention estimates a relevance score where presence of the relationship between the words is an important component of the score. To maintain high sensitivity while increasing specificity, it utilizes article-level concurrence as the last level of relevance.

Comparison of Information Retrieval Systems of MEDLINE

There are more than 30 retrieval services that use MEDLINE as their data source, some of which are shown in Table 1. Some use MEDLINE as the main or the only data source, such as PubMed, OVID, SLIM, askMEDLINE, and eTBLAST. Others use multiple databases, e.g. MedMiner. Some return articles as their main results (PubMed), while others return some digested form, such as a graph (Chilibot and ConceptLink). Some focus on data-mining (MedBlast and HAPI). Others focus on genomics or proteomics (GoPubMed and iHOP). Some are designed for “literature-based discovery”, finding relationships between biomedical concepts from MEDLINE that are not expressed in any article directly, e.g. Arrowsmith and BITOLA. Some are specialized in the classification of articles, e.g. AnneOTate, CISMeF, and MedMOLE.

The majority of these services do not estimate relevance scores. None of them incorporate any relationship between the words in computing the relevance score.

OVID supports a ‘proximity operator’ where the user can ask for the two keywords to be within some specified distance (measured by the number of words separating them). However, this feature does not recognize sentence boundaries. For example, a word at end of a sentence is considered adjacent to the word in the beginning of the next sentence, and is treated the same way as when the two words were adjacent within the same sentence. Moreover, there is no automatic feature to utilize the adjacency operator, for sorting the resulting articles by increasing distance between the keywords matched per article. The user has to manually submit multiple queries with increasing proximity distances to be able to have a gradient of distances. Also note that word-proximity has less obvious cut-off values, compared to ‘sentence’ which is a more clear-cut linguistic unit.

PubMed has a feature called “Related Articles”. After a search retrieves some articles, each article has a link that displays ‘related articles’ to it. These related articles in turn are sorted by a relevance score. However, this score does not incorporate the original query that the user submitted. In other words, given that many biomedical concepts can be expressed in an article, the article can be retrieved by very different queries sent by different users. Moreover, in all these instances, the related articles of the original article are exactly the same, irrespective of what concept the user was originally interested in. PubMed also gives the options to sort the search results by one of the four criteria: 1) Pub Date; 2) First Author; 3) Last Author; and 4) Journal. Importantly, these options do not necessarily reflect the relevance of an article to the user's query.

One may try to use some of the PubMed features to detect ‘relation’ between words for a multi-word query. Three methods could be used: 1) One can limit the search to the titles only. Then if the (two) words appear in the title, it has a high probability that some sort of relation is declared between them in the article. Although this method could attain fairly high specificity, it may miss relevant articles because it does not utilize any of the sentences of the abstract, i.e. it is potentially of low sensitivity. 2) If the two or more words the user is asking have hierarchical relation in the MeSH, then MeSH can show high specificity. For example, when the user is interested in adverse effects of antidepressant therapy, the MeSH subheading ‘adverse effects’ to the MeSH heading ‘antidepressive agents’ is a good query. A similar case is when all the query words map to a single MeSH term. For example, query ‘two dimensional gel electrophoresis’ maps to “electrophoresis, gel, two-dimensional” [MeSH Terms]. In such cases many of the retrieved articles can be relevant. 3) If the query words are mainly used consecutively in the article text, one may be able to use quoting (the operator “”), in order to instruct PubMed to retrieve articles where the words appear exactly (in the same proximity and order) as they are in the quoted phrase. However, these are not common cases.

Most of the queries sent to MEDLINE/PubMed are multi-word queries, where two or more words are included in the query. For these queries, the user can be looking for articles that are about 1) each word, and 2) some relationship between the words. Currently, the retrieval systems of MEDLINE (including PubMed) identify articles with the requested words but not their relationship. The majority of these services do not estimate relevance scores. None of them incorporate any relationship between the words in computing the relevance score. Detecting the relationships and estimating a better relevance score are the unique features characterizing this project.

There is a limit to the amount of text a user is willing or able to scan. By using a sentence level matching, ReleMed, one embodiment of the present invention, is able to deliver higher specificity, thus reducing false positive (FP) articles. Also, by introducing relevance metric, the most useful articles are shown first, where the user focuses most. By composing the matching sentences and highlighting the keywords, ReleMed shrinks the text and the time the user spends for the ‘scan & eliminate’ process (where the user reads the titles or quickly scans the abstracts, and decides whether to eliminate the article or leave it for the next round of more in-depth screening). The two examples shown in section C, entitled Preliminary Studies demonstrate that the higher precision attained at the start of results in ReleMed facilitates this type of screening.

Estimating Number of Words per Query in Queries Submitted to NLM's PubMed.

As an example, using the present invention, one day's worth of all queries submitted to NLM's PubMed [taken from ftp://ftp.ncbi.nih.gov/toolbox/pubmed/query-logs/as of June 2006] were studied. There were 2,995,234 queries. A computer script to process each query and split it into words was prepared. The split function used white-space as the delimiter to separate the words. The script also detected presence and count of Boolean operators AND and OR in each query. Finally it computed count of (non-operator) words in each query. The number of words in a query vs. the percentage of total submitted queries are as follows: 0/2.6; 1/14.51; 2/37.67; 4/11.65; 5/5.09; 6/2.66; 7/1.31; 8/0.83; 9/0.57; 10+/2.08.

There were times when a user clicks the submit button without typing any words in the search box (this was checked and this figure is not a computational error of the script).

There are 14.5% single-word queries. The rest of the queries (82.9%), the majority of them, are multi-word queries.

It is worth noting that within multi-word queries, there are queries where the whole query maps to a single MeSH term. For example, query ‘two dimensional gel electrophoresis’ maps to “electrophoresis, gel, two-dimensional” [MeSH Terms]. In such cases many of the retrieved articles can be relevant. However, this is not a common case. For the majority of multi-word queries, ascertaining presence of relation between the words in an article will improve the relevance score.

As stated, the majority of queries sent to MEDLINE/PubMed are multi-word queries, where two or more words are included in the query. For these queries, the user can be looking for articles that are about 1) each word, and 2) some relationship between the words. Currently, the retrieval systems of MEDLINE (including PubMed) identify articles with the requested words but not their relationship. Drawing on linguistics, the chance of the article claiming some relation between the two words is higher when they concur within a sentence than an article (or abstract). This was the basis for creating the present invention.

### SUMMARY OF THE INVENTION

The present invention overcomes the problems and disadvantages associated with current strategies and designs and provides new tools and methods for searching large knowledgebases or databases for relevant information.

One embodiment of the invention is directed to a method for searching and retrieving information from biomedical database.

In view of the above circumstance, this invention mainly intends to provide an information retrieval system capable of dealing with large-scale digital data repositories of textual and non-textual data while filtering out irrelevant information, and scoring the relevant data records according to their magnitude of relevance to the user's query, and then displaying the results sorted by such quantified relevance metric.

An information retrieval system according to an embodiment of the present invention is comprised of a data pre-processing component where each record of the data repository is taken, and transformed into a modified representation such that more accurate and more efficient automated information retrieval by machines becomes possible; a seconds data repository where the modified pre-processed data is saved; a user interface to receive and transform user's request; a search engine where transformed user query is matched against the transformed data records; and a computing infra-structure where for each single user query, multiple computer servers work simultaneously and in parallel.

In accordance with an embodiment of the present invention, the information retrieval system is implemented using commercial or freely available open source software, which include Perl to pre-process data and write the query application, MySQL to implement the database, Apache to serve the user's HTTP requests (HyperText Transfer Protocol), Fedora operating system, XHTML (eXtensible HyperText Markup Language) to produce the user interface and the reports, the Unified Medical Language System to implement ‘automatic term mapping’ and other data transformations, and open source search engines such as Lucene from Apache software foundation.

In accordance with at least one embodiment of the present invention, there is presented more than 130 vocabularies in the UMLS, where there are about 4 levels of usage restriction and licensing schema. In the level 0, there are about 63 standardized vocabularies that may be used based on a no-cost lease agreement with the NLM, where no further licensing with individual vocabulary vendors are required.

Other embodiments and advantages of the invention are set forth in part in the description, which follows, and in part, may be obvious from this description, or may be learned from the practice of the invention.

### DESCRIPTION OF THE DRAWINGS

FIG. 1 is a sample data record of MEDLINE in XML format.

FIG. 2 is a chart of the hierarchy of types of relationships.

FIG. 3 is two alternative formats of displaying search results.

FIG. 4 is a chart of the trend of precision in ReleMed versus PubMed for case study #1.

FIG. 5 is a chart of the trend of true positive rate for case study #2.

FIG. 6 is overall interface view.

FIG. 7 is an example of the HTML source code for the search page.

FIG. 8 is a screen snapshot showing an example for query “africa aids”.

FIG. 9 is a new window that opens automatically when the user clicks the “view content” button.

### DESCRIPTION OF THE INVENTION

### List of Abbreviations

FP: False Positive

HTML: HyperText Markup Language

HTTP: HyperText Transfer Protocol

LAMP: Linux Apache MySQL Perl

MeSH: Medical Subject Headings

PMID: PubMed ID

ReleMed: Sentence-level search Engine with Relevance score For MEDline

SIDS: Sudden Infant Death Syndrome

SQL: Structured Query Language

TP: True Positive

XHTML: eXtensible HyperText Markup Language

XML: eXtensible Markup Language

The present invention provides new and novel methods to define and measure relevance of documents found by a search engine. These methods can be applied to any search engine. In a preferred embodiment, the present invention is implemented and demonstrated using the MEDLINE database, a biomedical literature digital repository prepared by National Library of Medicine.

The Pre-Processing Component

In a preferred embodiment the information retrieval system uses NLM's MEDLINE as the digital data repository. However, the system operates on any digital data repository, wherein it contains one or more textual data fields, in artificial (human made) or natural languages (English or other languages), and where the digital data repository can be a fully structured relational database, or a less-structured repository like a collection of web pages, or of other types like recursive lists of any object types.

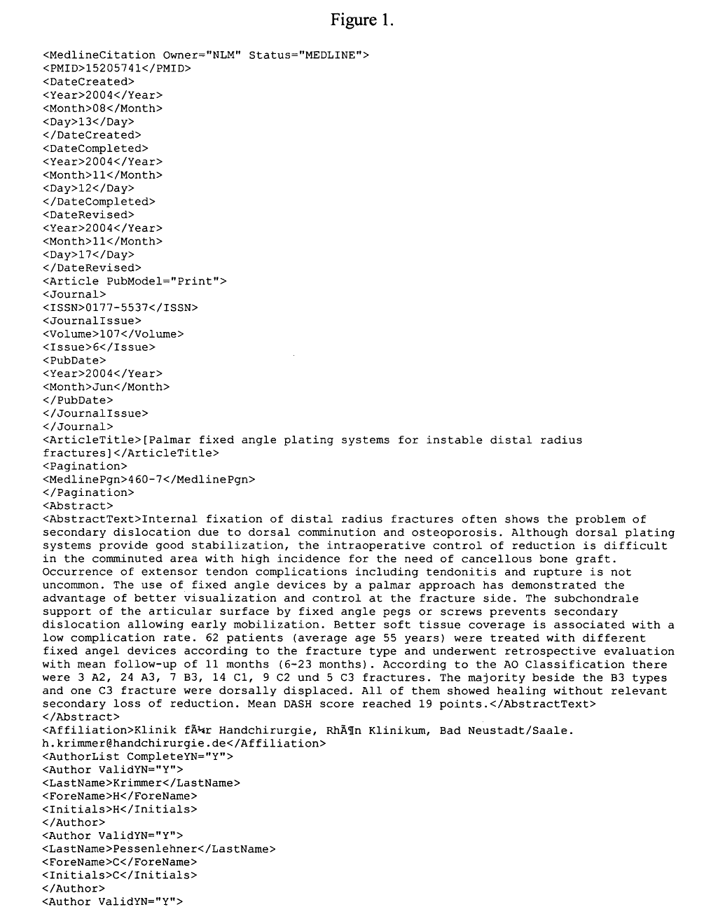

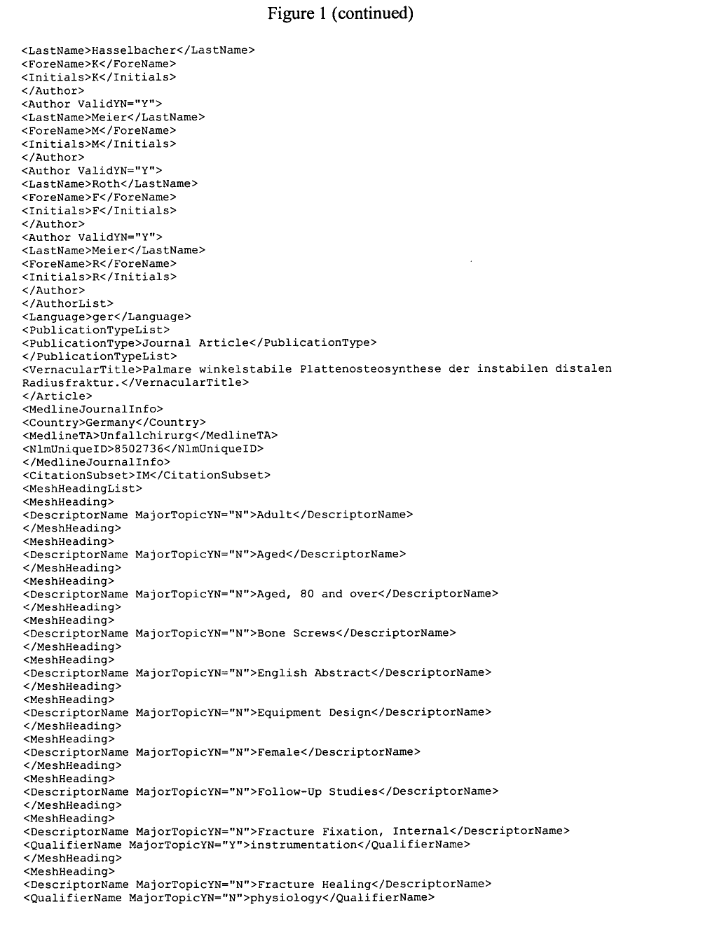

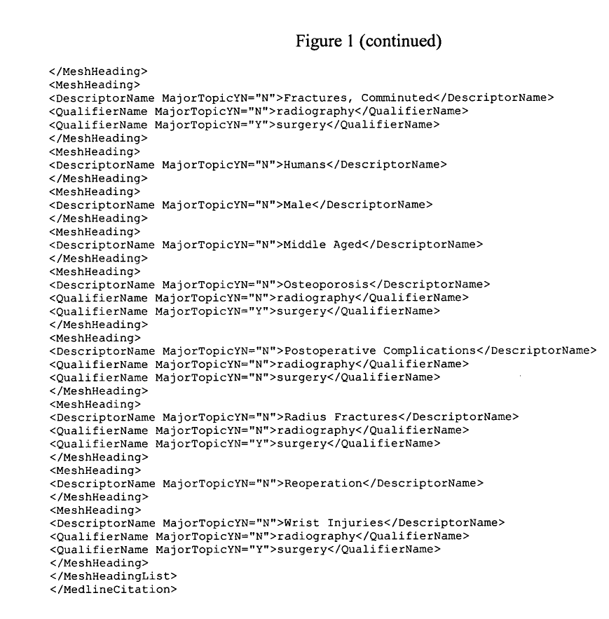

Through a no-cost lease contract with National Library of Medicine, one obtains MEDLINE data in extensible markup language (XML) format. FIG. 1 shows a sample data record.

One extracts title, abstract, citation information, and other useful fields from each XML article record, and then scan through the abstract text to detect and separate sentences. To detect a sentence one can use ‘.’, ‘?’, and ‘!’ as delimiters. One then joins back consecutive sentences where the period was sandwiched by single capital letters, some specific words such as ‘etc.’ and ‘et al.’, or by digits such as ‘0.05’.

The sentences generated by the above process are then loaded into a database. A prototype of such database can contain two tables, to load the sentences. Table 3 shows the fields and their definitions. The first table of the database (Table 3a) contains the sentences, the bulk of data, where an index is created for them. Field PMID (PubMed ID) is a unique integer number assigned by NLM to each article. Here PMID is used to link Table 3a to Table 3b. Field SNTNCID is equal to 1 for article title, and then 2 and bigger for abstract sentences. The second table of the database contains the citation information (author names, article title, journal name, publication date, issue and page numbers) for each NLM article. There is a many-to-one relationship between Table 3a and Table 3b. Table 3a is used to match user query to indexed articles, whereas Table 3b is used to retrieve citation information for a given PMID.

TABLE 3
Database tables, and their fields

| | | |
|---|---|---|
| Field | Description | Indexed |

Database Table 3a

| | | |
|---|---|---|
| PMID | PubMed ID number | no |
| SNTNCID | sentence ID number | no |
| Sentence | text of the sentence | yes |

Database Table 3b

| | | |
|---|---|---|
| PMID | PubMed ID number | yes |
| Citation | Citation information for the article | no |

In order to optimize the retrieval performance of the search engine, one needs to transform the article contents leased from NLM, and save them in a database with a different representation than the XML format published by the NLM. In building the data schema for such database one needs a knowledge model that incorporates a few items we investigated during our preliminary studies: 1) sentences being primary units of analysis not articles, 2) distinction between types of sentences, that is title, abstract sentences, and MeSH field, 3) ability to contain both the original article texts and their mappings to biomedical concepts, and 4) pre-processed relevance criteria and scores.

To process the text one executes the following steps:

1. Identification of biomedical concepts. In information extraction, entity extraction is viewed as distinct from relation extraction. However for MEDLINE, not all entity-looking phrases are entity types, plus some true entities embed relational information by virtue of their semantics. In preliminary studies using NLM's Unified Medical Language System (UMLS) biomedical concepts were detected in the published articles, with UMLS Mrconso.rrf table being the main useful file..

Methods to identify terms in a given text can be classified as 1) morphological rules, 2. parts-of-speech tagging engines, 3) grammar rules, 4) combined rule-based and dictionary-based methods, 5) support-vector machines, 6) hidden Markov model, and 7) classifiers such as naïve Bayes and decision-trees.

2. Using methods for resolution of “term ambiguity” (a term having multiple meanings) and “term synonymy” (multiple terms correspond to the same concept). Different methods for term detection are needed for 1) offline preprocessing of the articles, versus 2) realtime mapping of the user's query and matching it against the processed articles.

3. Processing of compound or complex sentences, via part-of-speech tagging. A good starting point is the Brill POS tagger package. Studies have shown that partitioning more complex sentences to simpler subunits decreases system errors in relation identification.

4. Recognition of relationships, via regular expressions, stemming, and detection of negative statements. Several computer languages have implemented regular expressions, with Perl being a comprehensive candidate. Porter stemming algorithm can be used for the stemming. And finally the algorithms implemented in the package NegEx were used as a starting point for recognition of negative statements. For more complex relationships more sophisticated NLP techniques are required. An example of a complex sentence is “p21 effectively inhibits Cdk2, Cdk3, Cdk4, and Cdk6 kinases (Ki 0.5-15 nM) but is much less effective toward Cdc2/cyclin B (Ki approximately 400 nM) and Cdk5/p35 (Ki>2 microM), and does not associate with Cdk7/cyclin H.” where relationships between p21 and Cdk7/cyclin H are hard to detect.

Methods to detect relationships can be classified in three families: 1) the “correlation methods” like the hidden Markov model, 2) “template matching” methods, and 3) “grammar-based parsing”. The present invention detects presence of relationships between the concepts in an article with more specificity by detecting it directly, rather than through a surrogate. The relationship detection also includes methods for detecting binary relationships, as well as tertiary, quaternary, and higher-order relationship. Converting all types of relationships to binary makes the computation more efficient, however, the combined binary statements are not exactly equivalent to the original higher order ones. A compromise is to keep both the representations in the database.

Among the correlation methods, and specifically among the concurrence methods, the sentence-level concurrence is a better statistical surrogate for detecting relationship than bigger chunks of text such as paragraph, abstract, or a longer document (such as full-text article). Also, the sentence-level concurrence which is more computationally tractable than other methods of detecting relations, such as grammar-based parsing and template matching.

To make the goals feasible within the limited time and budget resources, a method is to restrict the problem domain and to impose strong assumptions, such that accurate information extraction becomes possible/feasible. This will effectively eliminate the problem of text understanding. Another method is to define sub-problems, where each of them can be attacked more specifically. For example, extraction of nominal-based relational information may require different methods than the verbal-based relations.

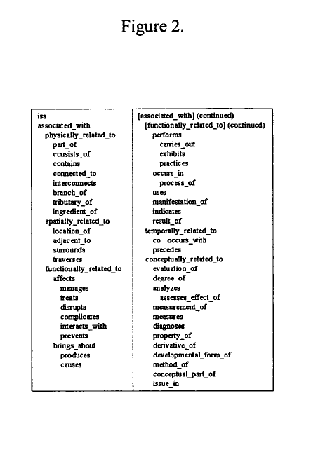

To detect and label types of relationships, one may use the hierarchies of Semantic Network in UMLS [http://www.nlm.nih.gov/research/umls/META3_current_relations.html]. They include two types in level 1 of the hierarchy (‘isa’ and ‘associated_with’), five types in level 2, 34 in level 3, and 13 in level 4, showed in FIG. 2. 5. Resolution of anaphoric terms. Identifying the arguments of the relations may not be enough for identifying the actual entities involved in the relation. Quite often anaphors (e.g., it, they) and sortal anaphoric noun phrases (e.g. the protein, both enzymes) are the actual arguments to a relation, but unfortunately are not specific enough to establish a unique reference to an entity or process. A starting point is the anaphora resolution method by Lappin and Leass.

Sentence-level parsing methods identify constructions like 1) Main predicate relational chunk in the sentence, 2) Subject nominal chunk, 3) Object nominal chunks, 4) Subordinate clauses (identifying also antecedents of relative clauses, and main predicates of object clauses), 5) Sentential coordination, 6) Preverbal adjuncts, and 7) Post Object target adjuncts (ambiguous between adjuncts and nominal modifiers). The following example shows a parsed sentence, including its biomedical concepts and the relationships between them, in an XML mark-up:

<Entity id=“83” Type=“small molecule”> Cyanide</Entity>,
<Entity id=“84” Type=“small molecule”>azide</Entity>,
<Entity id=“85” Type=“small molecule”>p-
hydroxymercuribenzoate</Entity>,
<Entity id=“86” Type=“small molecule”>iodoacetamide</Entity>, and
<Entity id=“87” Type=“small molecule”>oxygen </Entity>
<InhibitRelation id=“88” Inhibitor=“83, 84, 85, 86, 87”
Inhibitee=“82”>inhibit
</InhibitRelation>
<Entity id=“82” Antecedent=“81”>the enzyme</Entity>
<Entity id=“81” Type=“Protein”>Formate dehydrogenase</Entity>

Alternatively, the following is an example of parsing a sentence in a different format, in order to extract the relations between the biomedical concepts detected in the sentence “Recent studies have reported that mdm2 promotes the rapid degradation of p53 through the ubiquitin proteolytic pathway.”

```
[action, promote,
  [geneorprotein, mdm2],
  [action, degrade,
    [process, ubiquitin proteolytic pathway],
    [geneorprotein, p53]
  ],
]
```

One will incorporate open-access full-text articles into the database. There are reasons that this will improve the search results:

1. When there are sufficiently many sentences, then the abundance of occurrences of different events is more significant than the single occurrence of a useful sentence. In other words, the repeated occurrence of certain facts can enhance the quality of the discovery and strengthen the identification of particular relationships.

2. It is difficult to parse through complex sentences. However, the assumption is that if the facts in the sentence is common, it will be present in the same sufficiently large collection of sentences in shorter and easier sentences.

3. Comparing criteria like precision and recall across different existing systems, the systems gain tremendously when larger corpus of texts are analyzed.

A common property of the methods used to detect relationships directly is the large amount of computation they require. This makes them less suitable for real-time transactions, required for the type of a search engine we are proposing. This problem can be solved from two viewpoints: 1) modifying methods to shorten the response time, and 2) developing methods to transfer real-time computations to pre-processing phase and hence offline.

When identifying the concepts, a large variety of existing and emerging standardized vocabularies are used. They include the following sources from the Unified Medical Language System:

| | | |
|---|---|---|
| 1. | AI/RHEUM, 1993 | AIR93 |
| 2. | Alcohol and Other Drug Thesaurus, 2000 | AOD2000 |
| 3. | Authorized Osteopathic Thesaurus, 2003 | AOT2003 |
| 4. | Clinical Classifications Software, 2005 | CCS2005 |
| 5. | COSTAR, 1989-1995 | COSTAR_89-95 |
| 6. | CRISP Thesaurus, 2006 | CSP2006 |
| 7. | COSTART, 1995 | CST95 |
| 8. | Common Terminology Criteria for Adverse Events, 2003 | CTCAEV3 |
| 9. | DXplain, 1994 | DXP94 |
| 10. | Gene Ontology, 2006_01_20 | GO2006_01_20 |
| 11. | Healthcare Common Procedure Coding System, 2006 | HCPCS06 |
| 12. | HL7 Vocabulary Version 2.5, 2003_08_30 | HL7V2.5_2003_08_30 |
| 13. | HL7 Vocabulary Version 3.0, 2006_05 | HL7V3.0_2006_05 |
| 14. | HUGO Gene Nomenclature, 2005_04 | HUGO_2005_04 |
| 15. | ICD-9-CM, 2007 | ICD9CM_2007 |
| 16. | International Classification of Primary Care, 1993 | ICPC93 |
| 17. | ICPC, Basque Translation, 1993 | ICPCBAQ_1993 |
| 18. | ICPC, Danish Translation, 1993 | ICPCDAN_1993 |
| 19. | ICPC, Dutch Translation, 1993 | ICPCDUT_1993 |
| 20. | ICPC, Finnish Translation, 1993 | ICPCFIN_1993 |
| 21. | ICPC, French Translation, 1993 | ICPCFRE_1993 |
| 22. | ICPC, German Translation, 1993 | ICPCGER_1993 |
| 23. | ICPC, Hebrew Translation, 1993 | ICPCHEB_1993 |
| 24. | ICPC, Hungarian Translation, 1993 | ICPCHUN_1993 |
| 25. | ICPC, Italian Translation, 1993 | ICPCITA_1993 |
| 26. | ICPC, Norwegian Translation, 1993 | ICPCNOR_1993 |
| 27. | ICPC, Portuguese Translation, 1993 | ICPCPOR_1993 |
| 28. | ICPC, Spanish Translation, 1993 | ICPCSPA_1993 |
| 29. | ICPC, Swedish Translation, 1993 | ICPCSWE_1993 |
| 30. | Library of Congress Subject Headings, 1990 | LCH90 |
| 31. | LOINC 2.17 | LNC217 |
| 32. | MEDLINE (1996-2000) | MBD06 |
| 33. | McMaster University Epidemiology Terms, 1992 | MCM92 |
| 34. | MEDLINE (2001-2006) | MED06 |
| 35. | MedlinePlus Health Topics_2004_08_14, 20040814 | MEDLINEPLUS_20040814 |
| 36. | Medical Subject Headings, 2007_2006_08_08 | MSH2007_2006_08_08 |
| 37. | UMLS Metathesaurus | MTH |
| 38. | Metathesaurus CPT Hierarchical Terms, 2006 | MTHCH06 |
| 39. | Metathesaurus FDA National Drug Code Directory, 2006_08_04 | MTHFDA_2006_08_04 |
| 40. | Metathesaurus HCPCS Hierarchical Terms, 2006 | MTHHH06 |
| 41. | HL7 Vocabulary Version 2.5, 7-bit equivalents, 2003_08 | MTHHL7V2.5_2003_08 |
| 42. | Metathesaurus additional entry terms for ICD-9-CM, 2007 | MTHICD9_2007 |
| 43. | Metathesaurus Version of Minimal Standard Terminology Digestive . . . | MTHMST2001 |
| 44. | Metathesaurus Version of Minimal Standard Terminology Digestive . . . | MTHMSTFRE_2001 |
| 45. | Metathesaurus Version of Minimal Standard Terminology Digestive . . . | MTHMSTITA_2001 |
| 46. | Metathesaurus Forms of Physician Data Query, 2005 | MTHPDQ2005 |
| 47. | NCBI Taxonomy, 2006_01_04 | NCBI2006_01_04 |
| 48. | NCI modified Common Terminology Criteria for Adverse Events v3.0 . . . | NCI-CTCAEV3 |
| 49. | National Cancer Institute Thesaurus, 2006_03D | NCI2006_03D |
| 50. | NCI SEER ICD Neoplasm Code Mappings, 1999 | NCISEER_1999 |
| 51. | National Drug File - Reference Terminology, 2004_01 | NDFRT_2004_01 |
| 52. | National Library of Medicine Medline Data | NLM-MED |
| 53. | Physician Data Query, 2005 | PDQ2005 |
| 54. | Perioperative Nursing Data Set, 2nd edition, 2002 | PNDS2002 |
| 55. | Quick Medical Reference (QMR), 1996 | QMR96 |
| 56. | QMR clinically related terms from Randolph A. Miller, 1999 | RAM99 |
| 57. | RxNorm Vocabulary, 06AC_060901F | RXNORM_06AC_060901F |
| 58. | SNOMED Clinical Terms, Spanish Language Edition, 2006_04_30 | SCTSPA_2006_04_30 |
| 59. | SNOMED Clinical Terms, 2006_07_31 | SNOMEDCT_2006_07_31 |
| 60. | Standard Product Nomenclature, 2003 | SPN2003 |
| 61. | USP Model Guidelines, 2004 | USPMG_2004 |
| 62. | University of Washington Digital Anatomist, 1.7.3 | UWDA173 |
| 63. | Veterans Health Administration National Drug File, 2005_03_23, 2 . . . | VANDF_2005_03_23 |
| 64. | Alternative Billing Concepts, 2006 | ALT2006 |
| 65. | Beth Israel Vocabulary, 1.0 | BI98 |
| 66. | Canonical Clinical Problem Statement System, 1999 | CCPSS99 |
| 67. | Current Dental Terminology 2005 (CDT-5), 5 | CDT5 |
| 68. | Medical Entities Dictionary, 2003 | CPM2003 |
| 69. | Physicians' Current Procedural Terminology, Spanish Translation, . . . | CPT01SP |
| 70. | Current Procedural Terminology, 2006 | CPT2006 |
| 71. | Diseases Database, 2000 | DDB00 |
| 72. | German translation of ICD10, 1995 | DMDICD10_1995 |
| 73. | German translation of UMDNS, 1996 | DMDUMD_1996 |
| 74. | DSM-III-R, 1987 | DSM3R_1987 |
| 75. | DSM-IV, 1994 | DSM4_1994 |
| 76. | HCPCS Version of Current Dental Terminology 2005 (CDT-5), 5 | HCDT5 |
| 77. | HCPCS Version of Current Procedural Terminology (CPT), 2006 | HCPT06 |
| 78. | Home Health Care Classification, 2003 | HHC2003 |
| 79. | ICPC2E-ICD10 relationships from Dr. Henk Lamberts, 1998 | HLREL_1998 |
| 80. | ICD10, American English Equivalents, 1998 | ICD10AE_1998 |
| 81. | International Statistical Classification of Diseases and Related . . . | ICD10AMAE_2000 |
| 82. | International Statistical Classification of Diseases and Related . . . | ICD10AM_2000 |
| 83. | ICD10, Dutch Translation, 200403 | ICD10DUT_200403 |
| 84. | ICD10, 1998 | ICD10_1998 |
| 85. | International Classification of Primary Care 2nd Edition, Electr . . . | ICPC2EDUT_200203 |
| 86. | International Classification of Primary Care 2nd Edition, Electr . . . | ICPC2EENG_200203 |
| 87. | ICPC2-ICD10 Thesaurus, Dutch Translation, 200412 | ICPC2ICD10DUT_200412 |
| 88. | ICPC2-ICD10 Thesaurus, 200412 | ICPC2ICD10ENG_200412 |
| 89. | ICPC-2 PLUS | ICPC2P_2005 |
| 90. | Online Congenital Multiple Anomaly/Mental Retardation Syndromes, . . . | JABL99 |
| 91. | Master Drug Data Base, 2006_08_09 | MDDB_2006_08_09 |
| 92. | Medical Dictionary for Regulatory Activities Terminology (MedDRA . . . | MDR90 |
| 93. | Medical Dictionary for Regulatory Activities Terminology (MedDRA . . . | MDRDUT90 |
| 94. | Medical Dictionary for Regulatory Activities Terminology (MedDRA . . . | MDRFRE90 |
| 95. | Medical Dictionary for Regulatory Activities Terminology (MedDRA . . . | MDRGER90 |
| 96. | Medical Dictionary for Regulatory Activities Terminology (MedDRA . . . | MDRITA90 |
| 97. | Medical Dictionary for Regulatory Activities Terminology (MedDRA . . . | MDRPOR90 |
| 98. | Medical Dictionary for Regulatory Activities Terminology (MedDRA . . . | MDRSPA90 |
| 99. | Online Mendelian Inheritance in Man, 1993 | MIM93 |
| 100. | Multum MediSource Lexicon, 2006_08_01 | MMSL_2006_08_01 |
| 101. | Micromedex DRUGDEX, 2006_07_31 | MMX_2006_07_31 |
| 102. | Czech translation of the Medical Subject Headings, 2004 | MSHCZE2004 |
| 103. | Nederlandse vertaling van Mesh (Dutch translation of MeSH), 2005 | MSHDUT2005 |
| 104. | Finnish translations of the Medical Subject Headings, 2006 | MSHFIN2006 |
| 105. | Thesaurus Biomedical Francais/Anglais [French translation of MeS . . . | MSHFRE2006 |
| 106. | German translation of the Medical Subject Headings, 2006 | MSHGER2006 |
| 107. | Italian translation of Medical Subject Headings, 2006 | MSHITA2006 |
| 108. | JAMAS Japanese Medical Thesaurus (JJMT), 2005 | MSHJPN2005 |
| 109. | Descritores em Ciencias da Saude (Portuguese translation of the . . . | MSHPOR2006 |
| 110. | Russian Translation of MeSH, 2006 | MSHRUS2006 |
| 111. | Descritores en Ciencias de la Salud (Spanish translation of the . . . | MSHSPA2006 |
| 112. | Swedish translations of the Medical Subject Headings, 2005 | MSHSWE2005 |
| 113. | International Classification of Primary Care 2nd Edition, Electr . . . | MTHICPC2EAE_200203 |
| 114. | ICPC2-ICD10 Thesaurus, 7-bit Equivalents, 0412 | MTHICPC2ICD107B_0412 |
| 115. | ICPC2-ICD10 Thesaurus, American English Equivalents, 0412 | MTHICPC2ICD10AE_0412 |
| 116. | NANDA nursing diagnoses: definitions & classification, 2004 | NAN2004 |
| 117. | National Drug Data File Plus Source Vocabulary, 2006_08_04 | NDDF_2006_08_04 |
| 118. | Neuronames Brain Hierarchy, 1999 | NEU99 |
| 119. | Nursing Interventions Classification, 1999 | NIC99 |
| 120. | Nursing Outcomes Classification, 1997 | NOC97 |
| 121. | Omaha System, 1994 | OMS94 |
| 122. | Patient Care Data Set, 1997 | PCDS97 |
| 123. | Pharmacy Practice Activity Classification, 1998 | PPAC98 |
| 124. | Thesaurus of Psychological Index Terms, 2004 | PSY2004 |
| 125. | Clinical Terms Version 3 (CTV3) (Read Codes), 1999 | RCD99 |
| 126. | Read thesaurus, American English Equivalents, 1999 | RCDAE_1999 |
| 127. | Read thesaurus Americanized Synthesized Terms, 1999 | RCDSA_1999 |
| 128. | Read thesaurus, Synthesized Terms, 1999 | RCDSY_1999 |
| 129. | SNOMED-2, 2 | SNM2 |
| 130. | SNOMED International, 1998 | SNM198 |
| 131. | UltraSTAR, 1993 | ULT93 |
| 132. | The Universal Medical Device Nomenclature System (UMDNS), 2006 | UMD2006 |
| 133. | WHO Adverse Reaction Terminology, 1997 | WHO97 |
| 134. | WHOART, French Translation, 1997 | WHOFRE_1997 |
| 135. | WHOART, German Translation, 1997 | WHOGER_1997 |
| 136. | WHOART, Portuguese Translation, 1997 | WHOPOR_1997 |
| 137. | WHOART, Spanish Translation, 1997 | WHOSPA_1997 |

Generating a New Second Database

The pre-processed data will then be loaded and saved in a new second data repository (as compared to the original repository one started with). To attain higher computational performance, one may choose to save the data in un-normalized and/or pre-joined schema. This potentially will increase disk space utilization, but at the same time will decrease retrieval time.

The User Interface

One then implements a software application to receive a user's query, prepare the query in a computer language such as SQL (structured query language), interrogate the database, format the database results in a user-friendly language such as HTML language (HyperText Markup Language), and post it back to the user's browser.

As part of the operation, the user query is translated to the same types of concept IDs used in the pre-processing of the saved data. However, this translation needs to meet a fast response constraint, where it was not necessarily a constraint for the data pre-processing translations.

The Search Engine

Queries submitted to the system can simply be composed of one or a few words, separated by space. By default, the system uses Boolean ‘and’ operator to connect the words. Also, Boolean operators ‘or’ and ‘not’ are supported. One can use asterisk * for truncation, parentheses ( ) for grouping, and quotes “” for exact phrase matching. These are in accordance with PubMed query language.

One uses the Unified Medical Language System to implement ‘automatic term mapping’. When a query is submitted to ReleMed, synonyms for query words are found and added automatically to the query, using ‘or’ as the operator, thus improving the sensitivity of the search.

One can use freely available open source software to build the search engine, including Perl to pre-process data and write the query application, MySQL to implement the database, and Apache to serve the user's HTTP requests (HyperText Transfer Protocol). The computer servers can be installed with a Fedora operating system, hence the so-called LAMP architecture (Linux Apache MySQL Perl). XHTML (eXtensible HyperText Markup Language) was used to produce the user interface and the reports.

In a second preferred embodiment, open source search engines such as Lucene from Apache software foundation can be utilized in the system of this invention.

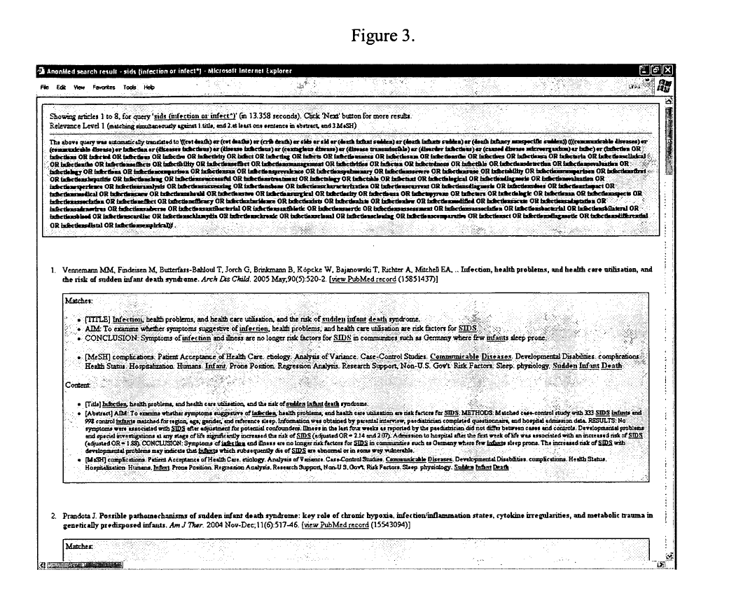

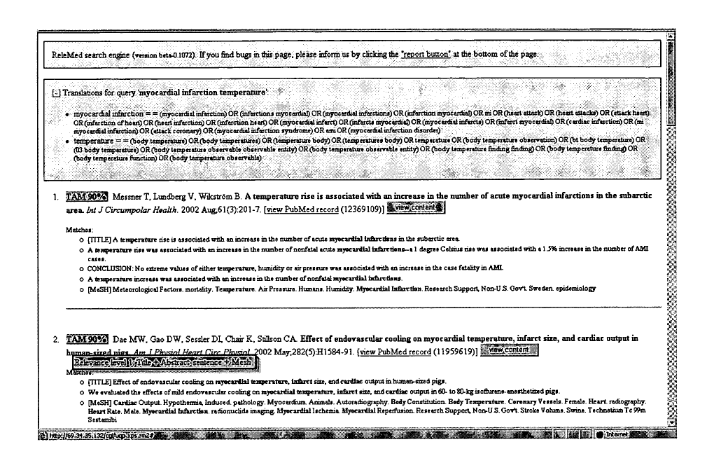

The system writes all the sentences matching the query in an HTML report, where the matched keywords are highlighted. The publication information for the article where the sentence was found is then added, as well as a hyperlink such that the user can easily navigate to the respective PubMed article, for potential drill down and for features in PubMed that have not been implemented in ReleMed. This format is shown in FIG. 3.

Relevance Conditions

The present invention defines the necessary and sufficient conditions for a biomedical article to be relevant for a query. The first condition is that all the query words must be present in the article, and the second is that at least one type of relationship has to be detected between the query words in the article. Starting with all the data records of the data repository, and given a user query, the system verifies the two conditions for each and every single data record. Each data record either satisfy the two conditions, or it doesn't. The system filters out the records that do not meet the two conditions. For the records that meet the conditions, the system then computes a relevance metric.

Relevance Metric

To compute the degree of relevance of each data record for a given user query, or in other words to quantify the relevance, the system computes the relevance score, a numeric score. The score is composed of a plurality of components, where each component is calculated by a specific function or operator. For example, ten of the operators are:

1) presence of query words,

2) presence of relationship between query words,

3) type of relationship,

4) type of semantic unit (i.e. type of sentence, such as title, first sentence in a paragraph, sentence designated as conclusion, etc),

Given an article record, with title (one sentence), a few abstract sentences, and MeSH terms [23] (concatenated together and treated as one sentence), one can assign importance weights to each of the three sentence types (title, abstract, MeSH). Then one can combine the types to define several levels of ‘relevance’. Thus one can try to measure how closely an article answers the user's query. Then one can sort the returned results by the relevance metric. This pushes the most relevant articles to the top of the result list, where the user would see the most relevant results first.

Table 4 defines eight relevance levels, hence a discrete metric (it is not a continuous number). Assuming user's query is ‘word1 word2’, in relevance level one, both the words should appear in title, and both words should appear in at least one sentence in abstract, and both words should appear in the MeSH terms, a stringent set of criteria. This we believe indicates that, in the majority of instances, the matched article would be of high relevance to the user's query, hence the first relevance level. The next levels are similarly defined, only the combinations of the types of sentences being different. Level 8 is different from the rest, as we first concatenate together all the sentences of an article, including title, all abstract sentences, and all the MeSH words. This makes one big ‘sentence’ from the whole article, which user's query is matched against. For example, word1 can be in the title, while word2 can be in MeSH words or in any of the abstract sentences (this is similar to PubMed's default). This level adds to the sensitivity of the search engine, thus reducing the probability of missing a relevant article. However level 8 has a low specificity, which is the reason we assigned the lowest relevance level to it.

TABLE 4
The eight relevance levels defined by ReleMed.

| Relevance level | Query must match |
|---|---|
| 1 | T and A and M |
| 2 | T and A |
| 3 | T and M |
| 4 | A and M |
| 5 | T |
| 6 | A |
| 7 | M |
| 8 | TAM |

T = title
A = at least one abstract sentence
M = concatenated MeSH terms
TAM = title, abstract, and MeSH concatenated into one sentence

5) Number and grouping of adjacent semantic units used for ascertainment of query word concurrences (like grouping of sentences into a paragraph, or other segments of document). At the same time, one can increase sensitivity by expanding the search window beyond each single sentence; hence analyzing multiple sentences at the same time.

6) Proximity of query words, measured by count of words separating them (expressed either as an absolute number or a range). With proximity operator, one can assign higher relevance to articles where the queried biomedical concepts appear closer to each other (measured by the number of words separating them). The adjacency operator is a special proximity where the distance is zero. It comes in two forms, where order of the concepts may matter or not.

7) Order of appearance of query words,

8) Frequency of each query word occurring in the semantic unit. The frequency operator counts number of occurrences of the query words, and hence giving a higher relevance score to articles with higher frequency.

9) Boolean operators such as ‘and’ ‘or’ ‘not’), and

10) Credence of the source journal, book, publisher) of each record, quantified by measures such as the ISI Impact Factor, sale rank, count of refereed URL links, etc.

A point of departure is that the system incorporates all of the operators simultaneously and by default, where each and every of them are used to define the numeric gradient of relevance in response to the submission of query terms by the user, without the user requesting one or more of the operators explicitly. This may necessitate fast and efficient real-time algorithms, as well as large amounts of computational power available for each single user query. Alternatively, one can use algorithms to move such computations from the submission real-time to the pre-processing off-line phase.

In accordance with the seventeenth aspect of this invention relative to the sixteenth aspect thereof, there is a limit to the amount of text a user is willing or able to scan. By using a sentence level matching, the system is able to deliver higher specificity, thus reducing false positive (FP) articles. Also, by introducing relevance metric, the most useful articles are shown first, where the user focuses most. By composing the matching sentences and highlighting the keywords, the system shrinks the text and the time the user spends for the ‘scan & eliminate’ process (where the user reads the titles or quickly scans the abstracts, and decides whether to eliminate the article or leave it for the next round of more in-depth screening). The two examples used in the patent demonstrated that the higher precision attained at the start of results facilitates this type of screening.

Certification

Published studies demonstrate that the system attains Precision (the ratio of the number of relevant records retrieved to the total number of irrelevant and relevant records retrieved) and Recall (the ratio of the number of relevant records retrieved to the total number of relevant records in the digital repository) approaching 100%. This makes it possible to use the system to certify accuracy and validity of results retrieved by other information retrieval systems.

Evaluation Method

Two case studies were conducted to evaluate the ReleMed search engine, and compare it to PubMed. The topics were chosen from real cases encountered in our daily practice. To decrease evaluation bias we concealed the source of each article (ReleMed or PubMed) from the raters (who evaluated the biomedical relevance of the articles). This was accomplished by presenting the articles in a unified format to the raters. The two questions addressed were: Q1. Given a query, is the collection of articles returned by ReleMed the same as PubMed? Q2. Are the most relevant articles listed at the top of the ReleMed results?

Starting with a query, we chose a pre-defined article count n, like 10. We queried ReleMed with the query, and saved PMIDs of the first n articles within each relevance level, hence giving a total of 8n PMIDs. Likewise we presented PubMed with the same query, and saved the first 8n PMIDs. Then we wrote a program into which we fed the two lists of 8n PMIDs. The program made a unique list of PMIDs. Then the program queried the database for each PMID, and wrote an HTML report where the article contents (all fields available under the ‘MEDLINE’ format, including title, abstract, and MeSH) are included. Keywords were highlighted in the HTML report, to facilitate evaluation process. Nothing in the report indicated which search engine (ReleMed or PubMed) retrieved each article. Two raters inspected the articles independently, and assigned true positive (TP) or false positive (FP) labels to each, thus defining the ‘gold standard’. To resolve potential discordance between the two raters, a discussion was made on each of the discordant articles to reach a consensus. Then the program transferred the TP and FP assignments back to the query results of each of the PubMed and ReleMed, thus ‘breaking the blind’. Finally we estimated the precision (=positive predictive value, which is percentage of retrieved articles that are relevant) for each of the relevance levels of ReleMed, and consecutive bins of size n in PubMed.

To analyze the precision data, and to attach statistical significance (by constructing 95% confidence bands for the precision curves), we used ‘local regression’ implemented in package ‘locfit’ of R statistical language. Also, to measure inter-rater agreement, we used Cohen's kappa, which measures the agreement between the evaluations of two raters when both are rating the same object.

The following examples illustrate embodiments of the invention, but should not be viewed as limiting the scope of the invention.

### EXAMPLE 1

### Role of ‘Infection’ in ‘Sudden Infant Death Syndrome’ (SIDS)

SIDS is death of an infant less than one year old that cannot be explained after thorough medical investigation. Despite years of research, no definitive cause has been found, but there are many potential factors proposed by investigators, such as the position of baby during sleep, the use of a pacifier, history of parents' smoking, recent infection, change in temperature, etc. In this example the user wants to retrieve articles on SIDS that link infection as a potential cause of death in SIDS (or explains absence of such a relationship).

We used the query ‘sids (infection or infect*)’ in both PubMed and ReleMed. We included the truncated word ‘infect*’ to automatically include all the variations of the word ‘infect’, such as infectious, infections, infective, etc. To include all other synonymous phrases (that do not necessarily contain the word ‘infect’), we included the word ‘infection’. This is necessary since the ‘automatic term mapping’ of the search engines only add synonyms for non-truncated words. We added the phrase ‘1900/1/1:2006/3/10[dp]’ to the query submitted to PubMed, to make the corpus of articles searched in the two search engines similar. This phrase limits “date of publication” to the range specified (March 10^{th} was the last date we updated ReleMed database for the purpose of this study).

Both the engines searched all articles in MEDLINE from the earliest available publication dates to 3/10/2006. PubMed returned 608 articles, whereas ReleMed returned 927. Twenty nine out of 608 articles of PubMed were not included in the ReleMed results. These 29 articles were of two groups. Group one was articles with a publication date of 3/10/2006 or earlier, but added to the MEDLINE after Mar. 10, 2006. Since this was the last date ReleMed database was updated (for the purpose of this study), these articles did not exist in ReleMed. The second group was articles where no variation or synonym for ‘infection’ existed in any field, but since PubMed ‘explodes’ a term to all of the narrower terms in the MeSH hierarchy tree under it, terms like ‘septicemia’ and ‘septic abortion’, as well as ‘corneal ulcer’ and ‘trachoma’, were included in the PubMed search but not ReleMed. Of 927 articles returned by ReleMed, 338 were not found by PubMed, for two reasons: 1. some synonyms for SIDS are not recognized by PubMed. An example is ‘cot death’. This term was more common during 70's and 80's. 2. The acronym ‘sids’ in the submitted query is mapped to ‘sudden infant death’. However in PubMed this longer phrase is only used to match to MeSH terms and not to abstract or title, thus missing some articles.

Table 5 shows count of articles in each ReleMed relevance level. We used a cutoff of n=10 to compose the PMID list. For levels where the total returned articles were smaller than 10, we used all available. This made a list of 74 PMIDs. We added the first 74 articles from PubMed, thus making a list of 148 PMIDs. Subsequently we omitted redundant PMIDs, and reduced the list to 111 unique PMIDs. The precisions were estimated by the method explained in the Evaluation section. The inter-rater agreement was 83% (19 discordant articles among the 111 unique PMIDs). The Kappa measurement of inter-rater agreement was 0.684, with a P-value of <0.001 (a Kappa of 1 indicates perfect agreement. A value of 0 indicates that agreement is no better than chance).

TABLE 5
Count of articles in each ReleMed relevance level for
the two case studies

Count of retrieved articles

| Relevance | Case study #1 | Case study #2 |
|---|---|---|
| L1 T&A&M | 32 | 0 |
| L2 T&A | 4 | 6 |
| L3 T&M | 36 | 0 |
| L4 A&M | 78 | 0 |
| L5 T | 12 | 2 |
| L6 A | 182 | 68 |
| L7 M | 290 | 0 |
| L8 TAM | 257 | 82 |
| Total | 891 | 158 |

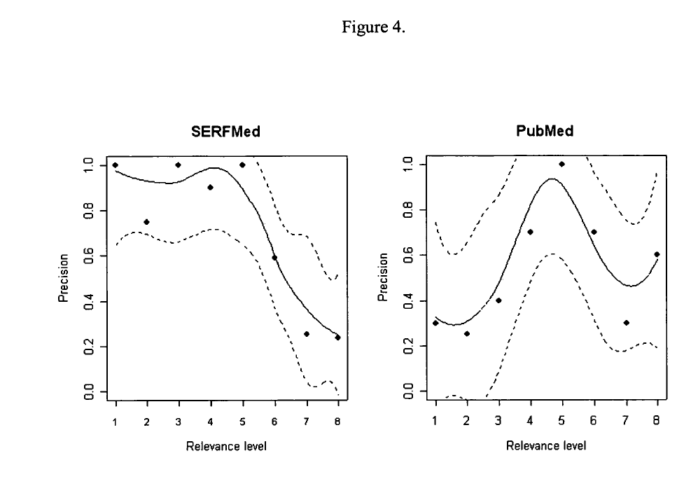

FIG. 4 shows the observed precision (the red dots) in the 8 groups of PMIDs per search engine. We fitted smoother curve (solid blue line) to the observed binary data (TP versus FP), to facilitate visualizing the trend. We also estimated 95% global confidence bands (the dashed black curves), for inference. Result pages in ReleMed start with a precision of 100%, while the initial precision in PubMed is 30%. There is a decreasing precision trend in ReleMed, but the trend in PubMed is not a monotone. One can draw decreasing lines (lines with negative slopes) for ReleMed that are completely inside its 95% confidence band, but not for PubMed. On the other hand, one can draw horizontal lines within the 95% band of PubMed, but not ReleMed. This suggests that the precision trends in the two search engines are significantly different. We note PubMed by default sorts the retrieved articles by reverse chronological order, which is not necessarily a relevance score. This supports the observation that PubMed results may attain their maximum precision anywhere along the list, and not always in the first page of results. The average precision in the first 74 articles of PubMed was 60.3%, while the estimated average precision for the first 74 articles of ReleMed was 98.4%.

The red dots show the observed precision in the 8 groups of PMIDs per search engine. The solid blue line is a fitted smoother curve for the observed binary data (true-positive versus false-positive). The dashed black curves are the estimated 95% global confidence bands.

Table 6 shows an example of a false positive article. All instances of the query words in the article are highlighted and shown. Both ‘infection’ and ‘SIDS’ are mentioned in two separate sentences of abstract, plus the fact that both of them are in MeSH terms. However, no relation between the two is declared. This article belongs to relevance level #7 of ReleMed and is #361 in the list of all articles. However, it is #41 in the PubMed result list (due to its publication date, which is the default sort of PubMed).

TABLE 6
A false positive article for query of case study #1, where query words do
concur, both in text and in MeSH (but not in the same sentence).

DiFranza JR, Aligne CA, Weitzman M. Prenatal and postnatal environmental tobacco smoke
exposure and children's health. Pediatrics. 2004 Apr; 113(4 Suppl): 1007-15. (PMID 15060193) ...
A large literature links both prenatal maternal smoking and children's ETS exposure to
decreased lung growth and increased rates of respiratory tract infections, otitis media, and
childhood asthma, with the severity of these problems increasing with increased exposure.
Sudden infant death syndrome, behavioral problems, neurocognitive decrements, and increased
rates of adolescent smoking also are associated with such exposures. ...
[MeSH] drug effects. etiology. adverse effects. Animals. Asthma. etiology. Child. Child
Behavior. drug effects. Embryonic and Fetal Development. Female. Humans. Infant.
Intelligence. drug effects. Otitis Media. etiology. Pregnancy. Respiratory Tract Infections.
Smoking. adverse effects. Sudden Infant Death. etiology. Tobacco Smoke Pollution analysis.

### EXAMPLE 2

### Finding ‘Questionnaires’ for Measuring ‘Health Literacy’

Health literacy is the degree to which individuals have the capacity to obtain, process, and understand basic health information and services needed to make appropriate health decisions. In this example, the user has a research project in which he wants to measure health literacy of the participants. He is interested in finding publications that give clues about existing questionnaires/instruments for health literacy.

We used the query “health literacy” and (instrument* or question* or measur* or scale* or assessment* or index* or test*) and PubMed returned 157 articles, whereas ReleMed returned 158 of which 153 were shared with PubMed (a 96.8% overlap). There were 4 articles in PubMed that were absent from ReleMed. All the four were articles with publication dates within the studied range (from the earliest publication date to 3/10/2006), but that have been added to the MEDLINE after Mar. 10, 2006 (the last update for ReleMed database). The five articles found by ReleMed but not by PubMed contained the term ‘health literacy’ and ‘test’ in abstract or title, but still could not be retrieved by PubMed. These seem to be false negatives for PubMed.

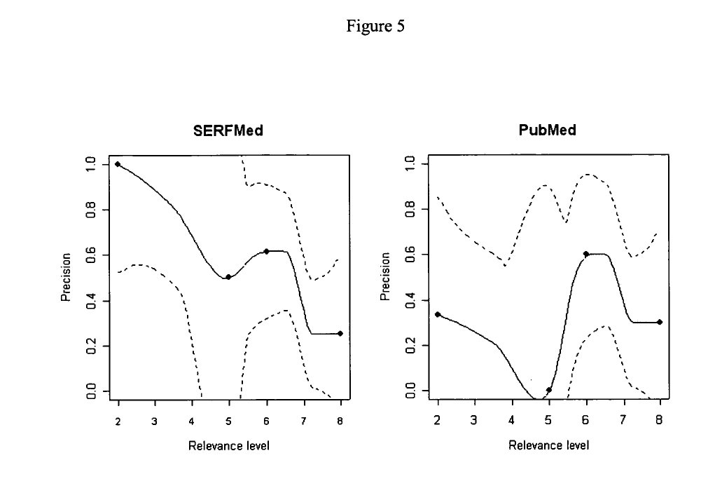

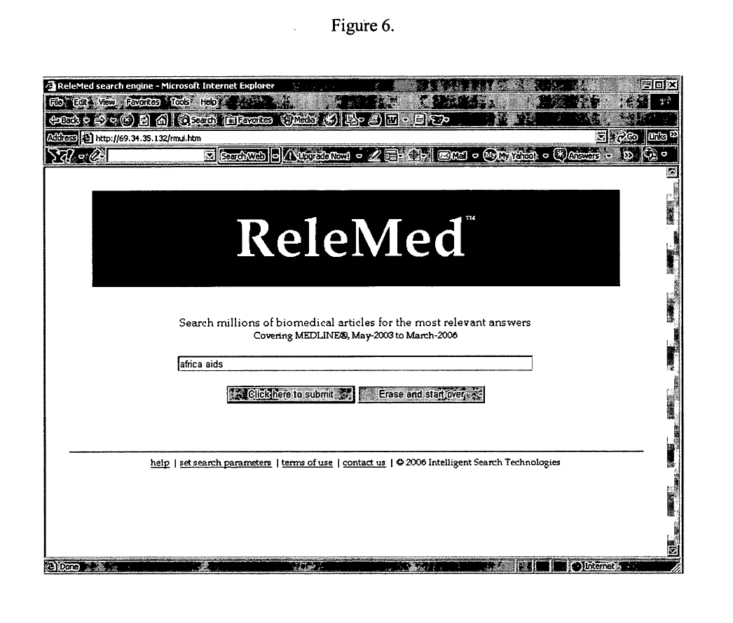

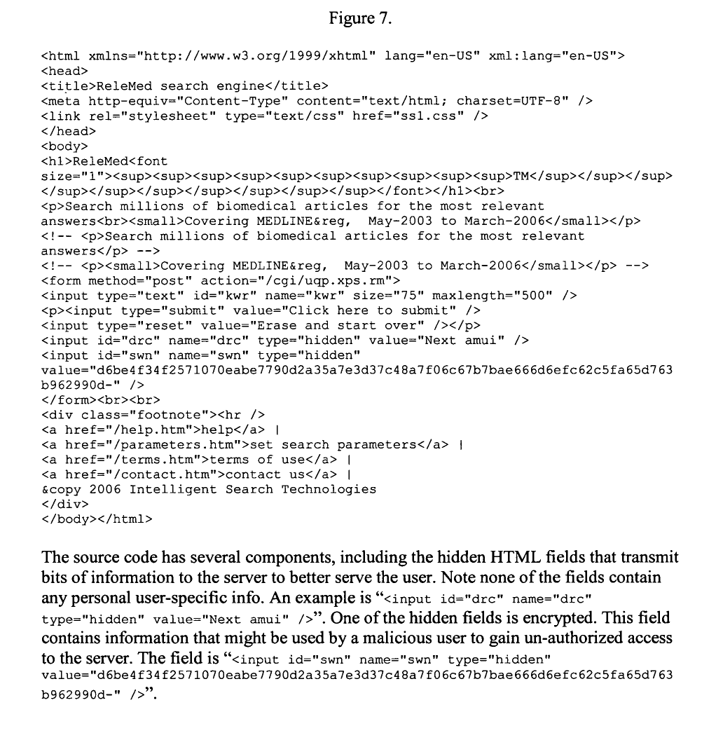

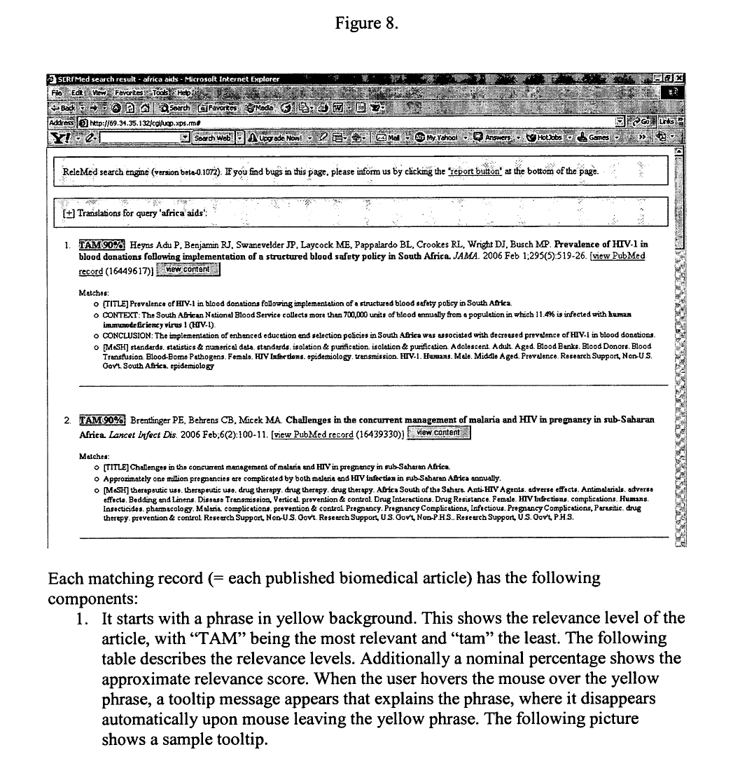

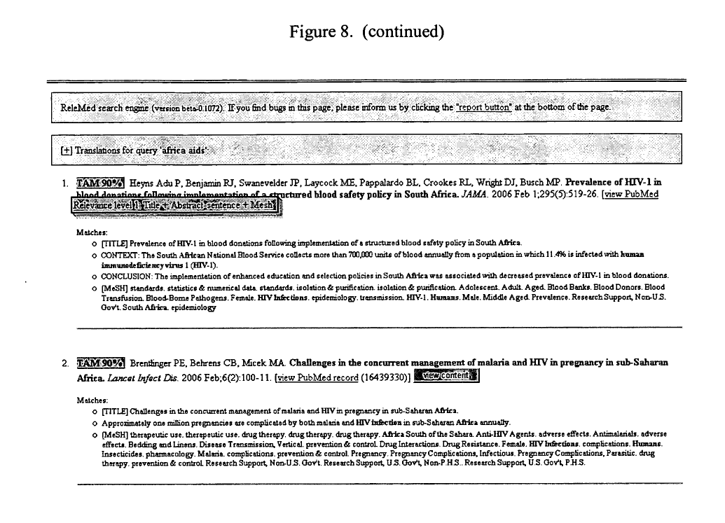

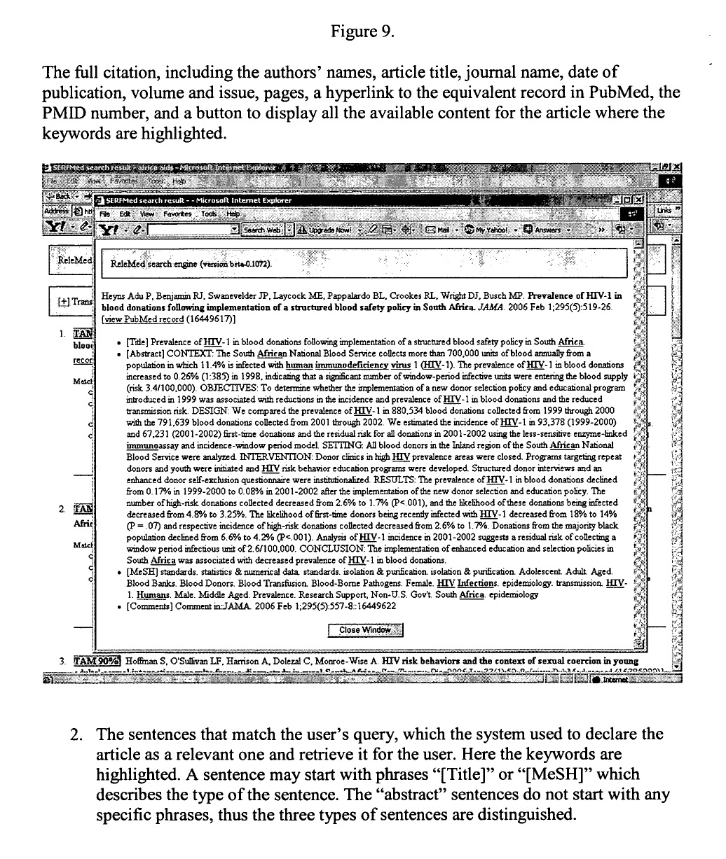

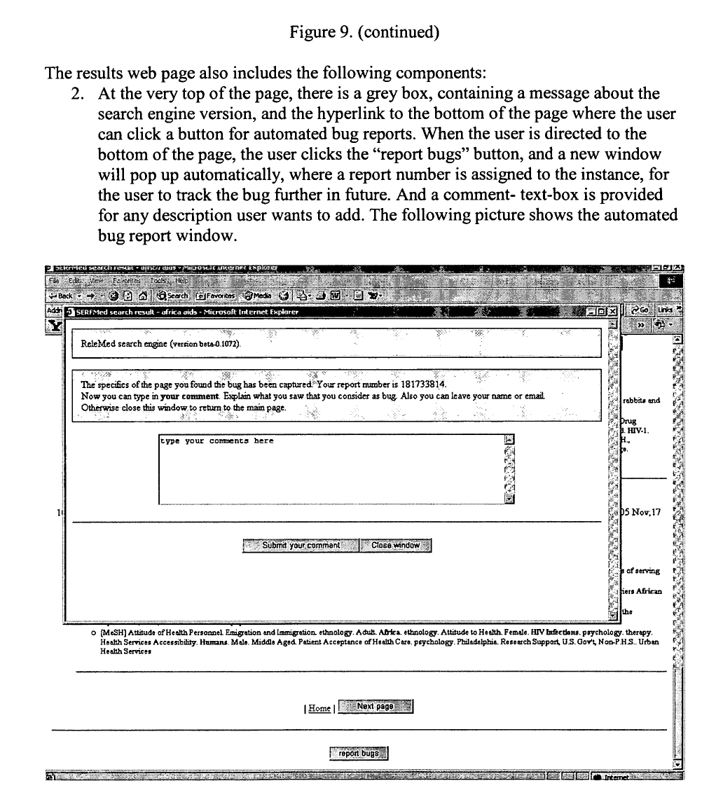

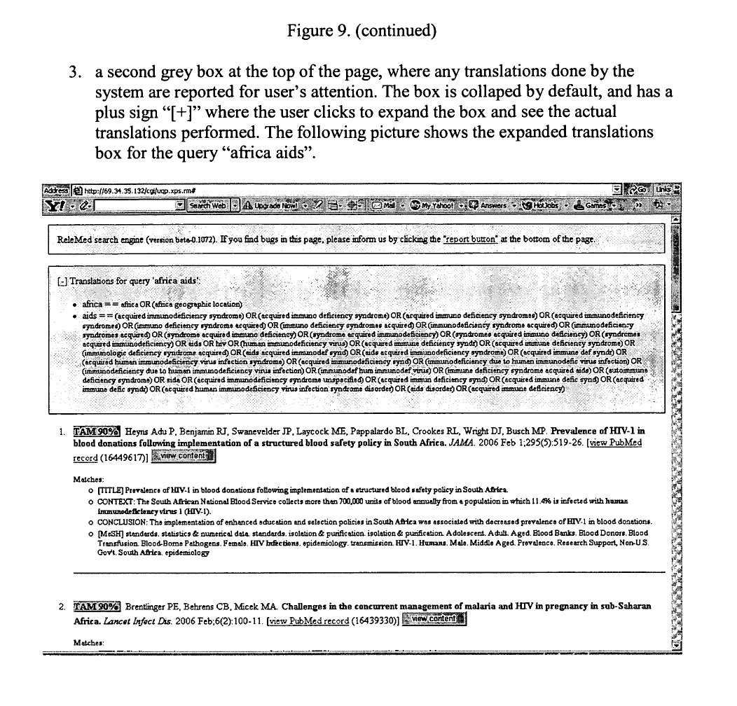

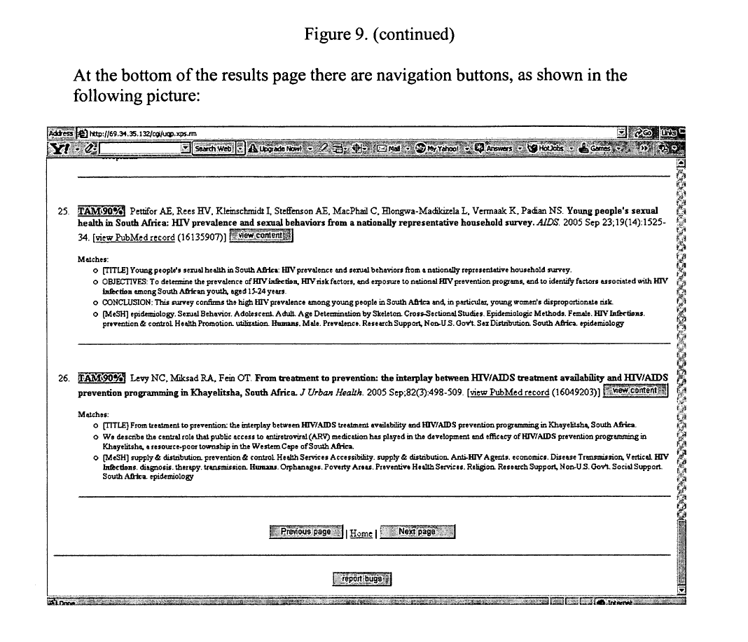

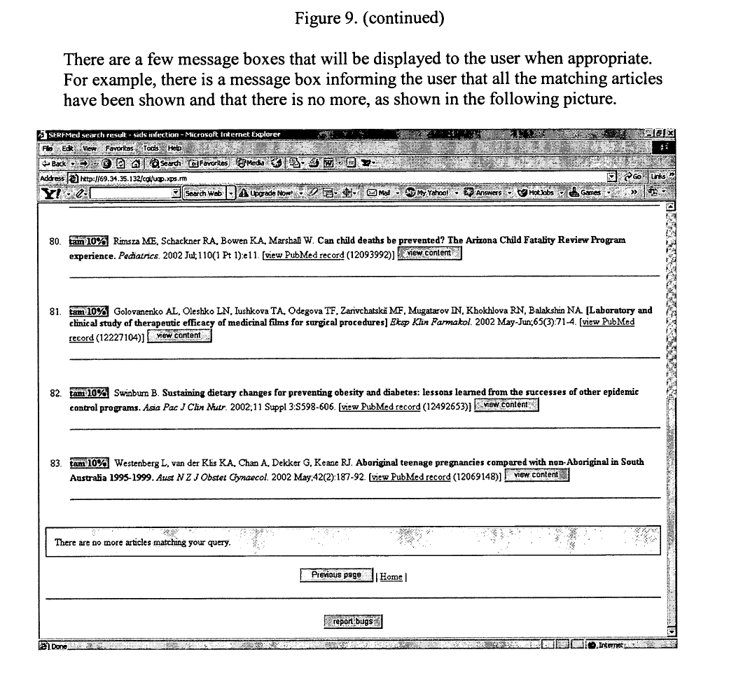

In FIG. 5 the precision starts from a much higher point (100%) in ReleMed compared to PubMed, and shows a decreasing trend. Note that the 95% confidence bands are rather wide in this case study, mostly due to the small number of articles per relevance level.

The red dots show the observed precision in the 8 groups of PMIDs per search engine. The solid blue line is a fitted smoother curve for the observed binary data (true-positive versus false-positive). The dashed black curves are the estimated 95% global confidence bands.

The precision in PubMed for the first 28 articles was 39.3%, while precision for the first 28 articles of ReleMed was estimated at 68.9%. The Kappa measure of inter-rater agreement was 0.496, which was significantly higher than chance (P-value<0.001).

The Distributed Parallel Computing Architecture

In a preliminary embodiment of the system, the search engine, including its databases, the applications running the regular expressions, automatic term mappings, and dynamic HTML generation, are all implemented in each single server. In other words, one has one or more servers that are exact replicates of each other. However, for some types of real-time text-processing (that are more complex and require more computations), in order to decrease response time, one may need to replace each single replicated server with a cluster, where the databases and the applications are divided into more tractable pieces, where each piece is housed by a separate server. This will distribute both the data and the instructions (the necessary respective applications) among machines within a computer cluster. In this architecture the machines within a cluster are not exact copies but they house different parts of the same search engine such that their cumulative effect reconstructs a single copy of the search engine. This will satisfy high performance goal. In the second level of clustering, one will have several replicates of such clusters, so that one can satisfy high availability and scalability goals.

More specifically, given n “chunk-servers”, with n being an integer 1<=n<inf, one will load each m servers (where m is an integer and 1<=m<n) with identical instructions and data chunks, where the chunks are the same within the m servers but differ from one group of m servers to other. For each cluster of n chunk servers, one will associate a master server, so that for a given query, it will make a list of all computational steps and their respective data chunks needed to be done; then the master server will send the first n/m of the items from the list to the servers, in a fashion similar to a Round Robin. The next batch of the items of the list will go to the servers starting from the server that finished its previous job the soonest. Thus the above architecture has both features: 1.speed and 2.error correction and fault tolerance.

To manage and connect servers in the clusters, a candidate method is the open source Red Hat Linux Global File System. Also, one will use modules for automated administration of the clusters of computers. This will enhance the substantial computing resources at low cost. By keeping chunks of data and their respective instruction codes and application on the same server, one will minimize data transmission across the cluster. Thus one minimizes data transmission down to only digested and reduced summary statistics and final results.

The nested clustered architecture of the distributed computing will enable a smooth scaling process. This scaling includes two dimensions. First it supports the increase in amount of documents and articles, the content, which the search engine will index and search. This will be accomplished by increasing the n, number of chunk-clusters within each level-one cluster. Second, all the n machines in a level-one cluster can be replicated and then form a new level-one n-machine cluster. These two clusters form a level-two cluster of two copies of the search engine (one can easily add to the number of cluster at this level). This dimension of the scaling will support increase in user query and traffic.

The user will access the system over network, including LAN and WAN (and the Internet), wired or wireless. The user's device can be a dummy terminal, mostly functioning as a standard input device to submit the query, plus a standard output device to display the results to the user. Alternatively the user's device can perform part of the computations. In this latter scenario, when the user submits his query, the system receives and performs a first round of information retrieval, and then sends the results to the user's machine. Such results may be cached locally. Subsequently in a second round of computation, the user's machine performs a second round of processing over the results, making them more specific and precise to the user's question. Either of the two steps can be performed individually or in combination. A distinction between the two steps is that the first step tries to be very sensitive, and at the same time to filter out majority of the data records. In the second step, the goal is to be more specific, and filter the intermediate results with more computationally intensive operators to fine-tune their relevance level to the user's question.

Other embodiments and uses of the invention will be apparent to those skilled in the art from consideration of the specification and practice of the invention disclosed herein. All references cited herein, including all publications, U.S. and foreign patents and patent applications, and U.S. patent application Ser. No. 11/165,578, entitled “Method, System, and Computer Algorithm for Discovery of Scientific Hypotheses and Corresponding Mechanisms” filed Jun. 24, 2005 which claims benefit of U.S. Provisional Application No. 60/584,207, entitled “Method, System, and Computer Algorithm for Discovery of Scientific Hypotheses and Corresponding Mechanisms” filed Jun. 30, 2004, are specifically and entirely incorporated by reference. It is intended that the specification and examples be considered exemplary only with the true scope and spirit of the invention indicated by the following claims.

1. A search engine for searching and retrieving information from a data repository comprising:
a pre-processing component that modifies the records of the data repository wherein:
i. the concepts of the language are identified in each record;
ii. term ambiguity and term synonymy are resolved;
iii. compound or complex semantic units are processed and simplified;
iv. presence and type of relationships between terms are detected; and
v. anaphoric terms and sortal anaphoric noun phrases are resolved, and the actual entities they refer to are identified;
a new, second data repository where the data is stored in the pre-processed, modified representation, containing all the concept IDs and the relation types;
a user interface wherein the user enters a query, and where the user query is translated to concept IDs of the language;
a data engine wherein concept IDs of the user query are matched against the concept IDs of the data records of said second data repository, and where the matching records are returned according to a relevance metric calculated for each data record; and
a multitude of computing hardware wherein said pre-processing component, second data repository, said user interface, and said data engine operate simultaneously and in parallel in response to a single user query.

2. The search engine of claim 1, wherein said information is retrieved by verifying two conditions for relevance of each data record to a given user query:
1) presence of user's query words in said record; and
2) presence of a relationship or a specific type of relation between the query words in said record.

3. The search engine of claim 1, wherein said data repository contains one or more textual data fields, in a plurality of languages.

4. The search engine of claim 1, wherein said concepts of the language are identified in the textual fields, using a plurality of methods including:
1) morphological rules;
2) parts-of-speech tagging engines;
3) grammar rules;
4) combined rule-based and dictionary-based methods;
5) support-vector machines;
6) hidden Markov model; and
7) classifiers such as naïve Bayes and decision-trees.

5. The identification of concepts in claim 4, wherein a plurality of existing and emerging standardized vocabularies are used simultaneously in data processing, including the vocabulary standards of the 137 sources from the Unified Medical Language System (UMLS).

6. The search engine of claim 1, wherein compound semantic units (sentences) are simplified, using a plurality of part-of-speech tagging processes.

7. The search engine of claim 1, wherein presence and type of relationships between terms are detected, using methods of:
1) grammar-based parsing;
2) template matching methods; and
3) correlation methods, including, but not limited to, the hidden Markov model and statistical concurrence.

8. The relationships of claim 7 are detected, with a plurality of tools, including Perl Regular Expressions, Porter stemming algorithm, and NegEx package for detection of negative statements.

9. The correlation methods of claim 7, wherein sentence-level concurrence is a preferred statistical surrogate for detecting a relationship than larger portions of text.

10. The types of relationships of claim 8, including the hierarchies of Semantic Network of UMLS, composed of two types in level 1 of the hierarchy (‘isa’ and ‘associated_with’), five types in level 2, thirty-four in level 3, and thirteen in level 4.

11. The search engine of claim 1, wherein said anaphoric terms and said sortal anaphoric noun phrases are resolved and identified, with a plurality of anaphora resolution methods.

12. The search engine of claim 1, wherein said relevance metric (numeric score) is computed using multiple relevance operators simultaneously, wherein all of the operators are incorporated by default, and all are used to define a numeric gradient of relevance in response to the submission of query terms by the user, without the user explicity requesting one or more of the operators.

13. The relevance operators of claim 12, including the following:
1) presence of query words;
2) presence of relationship between query words;
3) type of relationship;
4) type of semantic unit;
5) number and grouping of adjacent semantic units used for ascertainment of query word concurrences;
6) proximity of query words, measured by count of words separating them;
7) order of appearance of query words;
8) frequency of each query word occurring in the semantic unit;
9) Boolean operators; and
10) credence of the source of each record, quantified by measures including the ISI Impact Factor, sale rank, and count of refereed URL links.

14. The relevance metric of claim 12, wherein the retrieval process attains precision and recall approaching 100% and provides valid and reproducible comparisons for evaluating the completeness, accuracy, and usefulness of a result set for the given query provided by various systems.

15. The search engine of claim 1, wherein the computing hardware comprises one or more clusters of computer servers, wherein the databases and the applications are divided into tractable pieces, where each component is housed in a separate server, such that their cumulative effect reconstructs a single copy of said search engine.

16. The search engine of claim 1, further comprising implementation either as an internet-based application program or as a local computer-based application program.

17. The application program of claim 16, further comprising:
1) a first stage extraction from said data repository wherein said data records are scanned for relevance, and transmitted to the user's computer;
2) a second stage extraction wherein the relevant articles are scanned by the local application.

18. The application program of claim 17, wherein either said first stage or said second stage can be performed individually or together.
